(19) United States
(12) Patent Application Publication
(10) Pub. No.: US 2009/0113081 A1
(43) Pub. Date: Apr. 30, 2009

(54) COMMUNICATION APPARATUS, COMMUNICATION PROTOCOL, AND METHODS OF COMMUNICATING BETWEEN DEVICES

(75) Inventor: Kwong Yuen Wai, Aberdeen (CN)

Correspondence Address: RISSMAN JOBSE HENDRICKS & OLIVERIO, LLP, 100 Cambridge Street, Suite 2101, BOSTON, MA, 02114, US

(73) Assignee: National Electronics & Watch Co. Ltd., Aberdeen (HK)

(21) Appl. No.: 11/877,823

(22) Filed: Oct. 24, 2007

(51) Int. Cl. G06F 13/38; G06F 3/00; H04L 27/00

(52) U.S. Cl. 710/15; 375/295; 375/316; 710/305

(57) ABSTRACT

A method of wireless communication between personal devices includes wirelessly transmitting and/or wirelessly receiving a message at a low data rate and with low latency data. The message may include at least one of a sync data field, a channel frequency field, a channel period field, a channel type field, a data format field, a control command field, a security field, a network field, a network level field, a manufacturer number field, a device type field, a device number field, a manufacturing date field, a model number field, a device identification field, a field of information to be communicated, and a checksum field.

### TECHNICAL FIELD

The present invention relates generally to a communication apparatus, and, more particularly, to a novel communication protocol for communicating with peripheral devices.

### BACKGROUND

Communication between multiple communication devices is facilitated by a communication protocol. Many conventional communication protocols are complex, and may thus be undesirable for low data rate and low latency data applications. Conventional protocols for wireless and wired communication devices pose this same problem.

For example, a communication bus may comprise a universal serial bus (USB), which is an external bus standard that supports data transfer rates of up to 12 megabits per second. A single USB port can be used to connect up to 127 peripheral devices, such as mice, modems, keyboards, and the like. Another well-known external bus standard is IEEE 1394, also commonly referred to as Firewire, I-link and/or Lynx. The IEEE 1394 standard is a very fast external bus standard that supports data transfer rates of up to 400 megabits per second. A single IEEE 1394 port can be used to connect up to 63 external devices.

The problem with USB and IEEE 1394 is that they require complex communication protocols to handle bus arbitration functionality and other complex communication tasks. In many instances, these complex protocols are not necessary and it is desirable to have a more simplified communication bus and protocol.

It may be desirable to provide a communication device that communicates, wirelessly or wired, with other communication devices via a simplified yet robust communication protocol.

### SUMMARY OF THE INVENTION

In various aspects, the present disclosure is directed to a method of wireless communication between personal devices comprising wirelessly transmitting a message at a low data rate and with low latency data.

In various aspects, a method of wireless communication between personal devices comprising wirelessly receiving a message at a low data rate and with low latency data.

In some aspects, the present disclosure is directed to a communication device comprising at least one processor, a memory including instructions for the processor, and a bus for providing communication between the processor and the memory. The memory may further comprise instructions for wirelessly transmitting and/or wirelessly receiving a message at a low data rate and with low latency data.

According to various aspects, a wireless protocol may comprise a message structure including at least one of a sync data field, a channel frequency field, a channel period field, a channel type field, a data format field, a control command field, a security field, a network field, a network level field, a manufacturer number field, a device type field, a device number field, a manufacturing date field, a model number field, a device identification field, a field of information to be communicated, and a checksum field.

### BRIEF DESCRIPTION OF THE DRAWINGS

FIG. 1 illustrates a block diagram of an exemplary communications network environment in accordance with a possible embodiment of the invention;

FIG. 2 illustrates a block diagram of an exemplary communication device in accordance with a possible embodiment of the invention; and

FIG. 3 illustrates an exemplary protocol structure utilized by the communication device of FIG. 2 in the communications network environment of FIG. 1 in accordance with a possible embodiment of the invention.

### DETAILED DESCRIPTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used.

The present invention comprises a variety of embodiments, such as methods and apparatus and other embodiments that relate to the basic concepts of the invention.

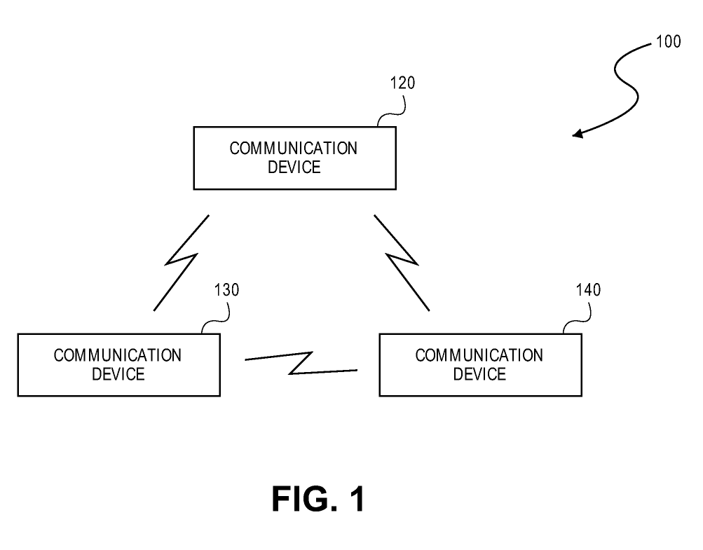

FIG. 1 illustrates a communications network environment 100 including a first communication device 120, a second communication device 130, and a third communication device 140. It should be appreciated that the communications network environment 100 may comprise two communication devices or more than three communication devices without departing from the teachings of the disclosure.

According to various aspects, the first communication device 120, the second communication device 130, and/or the third communication device 140 may comprise a wireless communication device. For example, the first, second and/or third communication device 120, 130, 140 may comprise a wrist-worn electronic device (e.g., a watch), a personal digital assistant (PDA), a personal computer, a pocket personal computer (PocketPC), a wireless telephone, an MP3 player, a heart rate monitor, a bike computer, or the like. The first, second, and third communication devices 120, 130, 140 may communicate with one another and/or with other communication devices (not shown) via, for example, radio frequency (RF) links, Bluetooth signals, Zigbee, or the like. For example, the first, second, and third communication devices may communicate via a 2.4 GHz industrial, scientific, and medical (ISM) band, which can be used worldwide. Such an ISM band may be designed for short-range half-duplex RF links. Integrated circuits configured to transmit and/or receive data using such ISM bands are well known by persons skilled in the art.

According to some aspects, the first communication device 120, the second communication device 130, and/or the third communication device 140 may comprise a communication device connectable to one of the other devices via a wired connection. For example, two or more of the communication devices 120, 130, 140 may be connectable via a serial bus or the like.

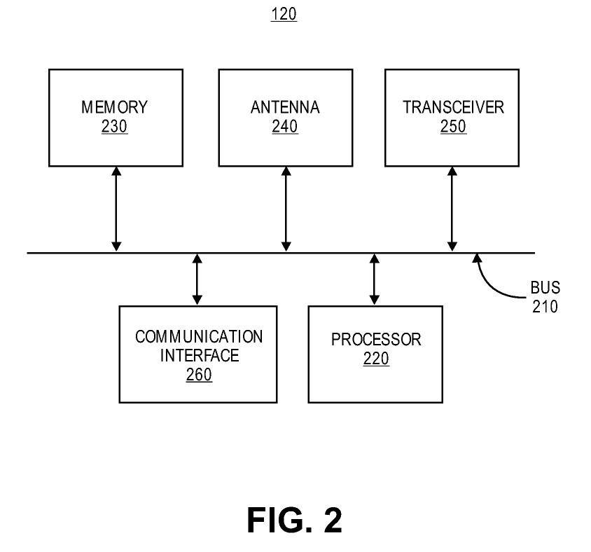

FIG. 2 illustrates a block diagram of an exemplary first communication device 120 in accordance with a possible embodiment of the invention. The exemplary wireless communication device 120 may include a bus 210, a processor 220, a memory 230, an antenna 240, a transceiver 250, and a communication interface 260. Bus 210 may permit communication among the components of the wireless communication device 120.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Transceiver 250 may include one or more transmitters and receivers. The transceiver 250 may include sufficient functionality to interface with any network or communications station and may be defined by hardware or software in any manner known to one of skill in the art. The processor 220 is cooperatively operable with the transceiver 250 to support bi-directional communications with the second communication device 130, the third communication device 140, or another communication device (not shown).

According to some aspects of the disclosure, the transceiver 250 may be replaced by a transmitter (not shown) configured to provide unidirectional communication with another communication device. In various aspects, the transceiver 250 may be replaced by a receiver (not shown) configured to provide unidirectional communication with another communication device.

Communication interface 260 may include any mechanism that facilitates communication via the communications network 110. For example, communication interface 260 may include any mechanism(s) for assisting the transceiver 250 in communicating with other devices and/or systems via wired or wireless connections. For example, in the case of wireless communications, the interface 260 may include a wireless modem. In the case of wired communications, the interface 260 may include a serial device communication bus, which may be known in the art.

The first communication device 120 may perform functions in response to processor 220 by executing sequences of instructions contained in a computer-readable medium, such as, for example, memory 230. Such instructions may be read into memory 230 from another computer-readable medium, such as a storage device or from a separate device via communication interface 260. Such instructions may include a protocol structure for communication between communication devices 120, 130, 140.

The communications network environment 100 and the first communication device 120 illustrated in FIGS. 1-2 and the related discussion are intended to provide a brief, general description of a suitable computing environment in which the invention may be implemented. Although not required, the invention will be described, at least in part, in the general context of computer-executable instructions, such as program modules, being executed by the first, second, and/or third communication device 120, 130, 140, such as a communications server or general purpose computer. Generally, program modules include routine programs, objects, components, data structures, etc. that perform particular tasks or implement particular abstract data types. Moreover, those skilled in the art will appreciate that other embodiments of the invention may be practiced in communication network environments with many types and combinations of communication equipment and computer system configurations, including cellular devices, mobile communication devices, personal computers, hand-held devices, multi-processor systems, microprocessor-based or programmable consumer electronics, and the like. For example, an embodiment can be practiced in a communication network that includes a personal computer and a mobile electronic device configured to communicate with one another.

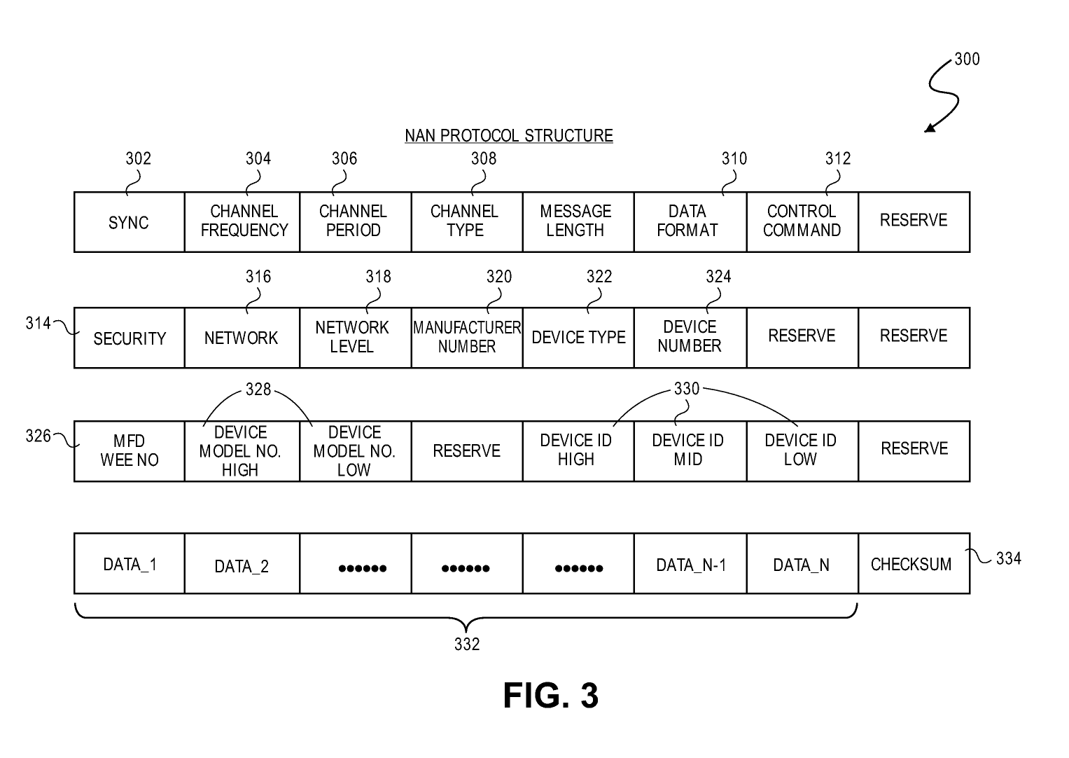

FIG. 3 illustrates an exemplary protocol structure 300 showing a data format for communicating between the first, second, and third communication devices 120, 130, 140 and/or other communication devices (not shown). The exemplary protocol structure 300 comprises a 256-bit message structure. The protocol structure 300 includes a Sync module 302 that provides an 8-bit setup sync between a transmitter and a receiver disposed in two communications devices. A Channel Frequency module 304 is an 8-bit field that controls the frequency of that channel. The frequency can be selected from a range of 2.402 GHz to 2.48 GHz.

A Channel Period module 306 is an 8-bit field that defines the period of a data package sent from a transmitter to a receiver. Based on the time interval, the receiver can link to the transmitter automatically. The period can be selected from a range of 0.1 Hz to 200 Hz. A Channel Type module 308 is an 8-bit field that defines the type of communication being accomplished. For example, the channel type may be Receive Only, Transmit Only, Bidirectional Receive, Bidirectional Transmit, and the like.

A Date Format module 310 is an 8-bit field that identifies the data type, for example, Broadcast, Acknowledge, Burst, or the like. A Control Command module 312 is an 8-bit field that is used to send out a special command such as self-test or the like. For normal operation, the Control Command module may be set to zero. A Security module 314 is an 8-bit field that can be used for data encryption. When there is no security setting, this module may be set to zero.

A Network module 316 is an 8-bit field that defines the network. The Network module 316 provides the ability to set up a network for an organization. As a result, devices that belong to the aforementioned organization can communicate with one another. A private network can be established to ensure network privacy and to restrict access only to intended participating devices. In the case of a public network, the Organization module 316 can be set to zero, thereby allowing all devices to access the network. A Network Level module 318 is an 8-bit field that provides varied levels of access control for a network. When there is no limit for access control, this module may be set to zero.

A Manufacturer Number module 320 is an 8-bit field that provides a number for each manufacturer. Similar devices from different manufacturers can thus be prevented from picking up signals from devices from the other manufacturer. If several manufacturers choose to share one or more devices, this module can be set to zero.

A Device Type module 322 is an 8-bit field that defines the function of a device. For example, the device may be a speed sensor for a bike computer or for a heart rate sensor chest strap. A Device Number module 324 is an 8-bit field that provides a code to define the number or version of the device type.

A MFD Week No. module 326 is an 8-bit field that identifies the manufacturing date in the form of a week number ranging from 1 to 52. A Model No. module 328 is a 16-bit field that shows the model number of the device. A Device ID module 330 is a 24-bit field that provides an ID number for the device. The ID number may be a serial number for the device or a random number generated so that it will not be confused with other ID numbers associated with the same device type.

One or more Data modules 332 include data or information for communication. For example, the Data modules 332 may include a plurality of 8-bit modules from Data_1 to Data_N totaling a number of bits equal to the Nth factor of 8. A Checksum module 334 is an 8-bit module used for error checking for a message of the protocol structure 300.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

It will be apparent to those skilled in the art that various modifications and variations can be made in the devices and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A method of wireless communication between personal devices, the method comprising:
wirelessly transmitting a message at a low data rate and with low latency data.

2. The method of claim 1, wherein said message comprises at least one of a sync data field, a channel frequency field, a channel period field, a channel type field, a data format field, a control command field, a security field, a network field, a network level field, a manufacturer number field, a device type field, a device number field, a manufacturing date field, a model number field, a device identification field, a field of information to be communicated, and a checksum field.

3. The method of claim 1, wherein said message comprises an 8-bit sync data field, followed by an 8-bit channel frequency field, followed by an 8-bit channel period field, followed by an 8-bit channel type field, followed by an 8-bit data format field, followed by an 8-bit control command field, followed by an 8-bit security field, followed by an 8-bit network field, followed by an 8-bit network level field, followed by an 8-bit manufacturer number field, followed by an 8-bit device type field, followed by an 8-bit device number field, followed by an 8-bit manufacturing date field, followed by a 16-bit model number field, followed by a 24-bit device identification field, followed by a field of information to be communicated, which is followed by an 8-bit checksum field.

4. The method of claim 3, wherein the message comprises a 256-bit message.

5. The method of claim 1, wherein said wirelessly transmitting comprises wirelessly transmitting a message by one of radio frequency links, Bluetooth signals, and Zigbee.

6. The method of claim 1, wherein said wirelessly transmitting comprises wirelessly transmitting a 2.4 GHz industrial, scientific, and medical band signal.

7. A method of wireless communication between personal devices, the method comprising:
wirelessly receiving a message at a low data rate and with low latency data.

8. The method of claim 7, wherein said message comprises at least one of a sync data field, a channel frequency field, a channel period field, a channel type field, a data format field, a control command field, a security field, a network field, a network level field, a manufacturer number field, a device type field, a device number field, a manufacturing date field, a model number field, a device identification field, a field of information to be communicated, and a checksum field.

9. The method of claim 7, wherein said message comprises an 8-bit sync data field, followed by an 8-bit channel frequency field, followed by an 8-bit channel period field, followed by an 8-bit channel type field, followed by an 8-bit data format field, followed by an 8-bit control command field, followed by an 8-bit security field, followed by an 8-bit network field, followed by an 8-bit network level field, followed by an 8-bit manufacturer number field, followed by an 8-bit device type field, followed by an 8-bit device number field, followed by an 8-bit manufacturing date field, followed by a 16-bit model number field, followed by a 24-bit device identification field, followed by a field of information to be communicated, which is followed by an 8-bit checksum field.

10. The method of claim 9, wherein the message comprises a 256-bit message.

11. The method of claim 7, wherein said wirelessly receiving comprises wirelessly receiving a message by one of radio frequency links, Bluetooth signals, and Zigbee.

12. The method of claim 7, wherein said wirelessly receiving comprises wirelessly receiving a 2.4 GHz industrial, scientific, and medical band signal.

13. A communication device comprising:
at least one processor;
a memory including instructions for the processor; and
a bus for providing communication between the processor and the memory, the memory further comprising instructions for at least one of wirelessly transmitting and wirelessly receiving a message at a low data rate and with low latency data.

14. The communication device of claim 13, wherein said message comprises at least one of a sync data field, a channel frequency field, a channel period field, a channel type field, a data format field, a control command field, a security field, a network field, a network level field, a manufacturer number field, a device type field, a device number field, a manufacturing date field, a model number field, a device identification field, a field of information to be communicated, and a checksum field.

15. The communication device of claim 13, wherein said message comprises an 8-bit sync data field, followed by an 8-bit channel frequency field, followed by an 8-bit channel period field, followed by an 8-bit channel type field, followed by an 8-bit data format field, followed by an 8-bit control command field, followed by an 8-bit security field, followed by an 8-bit network field, followed by an 8-bit network level field, followed by an 8-bit manufacturer number field, followed by an 8-bit device type field, followed by an 8-bit device number field, followed by an 8-bit manufacturing date field, followed by a 16-bit model number field, followed by a 24-bit device identification field, followed by a field of information to be communicated, which is followed by an 8-bit checksum field.

16. The communication device of claim 15, wherein the message comprises a 256-bit message.

17. The communication device of claim 13, wherein the communication device comprises one of a transmitter, a receiver, and a transceiver.

18. The communication device of claim 13, wherein the communication device comprises a personal communication device.

19. The communication device of claim 13, wherein the communication device comprises one of a wrist-worn electronic device, a personal digital assistant, a personal computer, a pocket personal computer, a wireless telephone, an MP3 player, a heart rate monitor, a bike computer.
